(19) United States
(12) Patent Application Publication
(10) Pub. No.: US 2010/0288459 A1
(43) Pub. Date: Nov. 18, 2010

(54) INDUSTRIAL FABRIC FOR FORMING AND PRESSING

(76) Inventor: Senri Ito, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 12/734,180

(22) PCT Filed: Oct. 21, 2008
(86) PCT No.: PCT/JP2008/069040

§ 371 Date: Jul. 15, 2010

(30) Foreign Application Priority Data
Nov. 30, 2007 (JP) 2007-310818

(51) Int. Cl. D21G 9/00; B28B 3/00

(52) U.S. Cl. 162/289; 425/363

(57) ABSTRACT

The object of the present invention is to provide an industrial fabric used for forming and pressing building material which is capable of exhibiting a good water suction property, while at the same time of preventing spots from being generated and bristles from being fallen out even if it is repeatedly used for forming and pressing building material and a strong washing shower is applied thereto.

The present invention provides a industrial fabric used for a forming process and a pressing process comprises one-layer fabric including warps and wefts constituting the fabric at least a part of which is intertwined by small-diameter raw yarns and fibers of the small-diameter raw yarns are crossed by jetting water in a columnar stream or a spray stream thereto, or multi-layer fabric including warps and wefts constituting an upper surface side layer at least a part of which is intertwined by small-diameter raw yarns and fibers of the small-diameter raw yarns are crossed by jetting water in a columnar stream or a spray stream thereto.

### TECHNICAL FIELD OF THE INVENTION

The present invention relates to an industrial fabric used for forming and pressing building material in the form of ceramics and slate, web or pulp which is capable of preventing spots from being generated and bristles from being fallen out.

### BACKGROUND ART

Conventionally, in a process of forming building material in the form of ceramics and slate, or a process of forming web or pulp, a wet object to be formed fed on the fabric is hydrated by a gravity-hydrating upon its transportation, a pressurized hydrating through a pressing roll, or suction-hydrating through a forced suction device such as a suction box. A needle felt including a fine structure which is formed by filling batt with short fibers by means of a needle punch technique using a dedicated needle is utilized as a basis formed to be an endless fabric (refer to Japanese Patent Publication 1).

Since a grid shape or an undulation on a surface of the fabric is rolled on a surface of the formed object which has been pressed and water-sucked at a pressing section, in particular, the fabric is required to have a fine and smooth surface. In addition, the fineness of the fabric structure is required because the building material such as slate or tiles is mainly made of very fine powder material.

In short, the material can leak through a mere grid space of the fabric, so that it is difficult to manufacture the object with a desired thickness, basis weight, and marks of the fabric can be rolled on the object in a case where the fabric in the form of the grid is used. That is why such a needle felt described above has been used in many occasions.

However, in the needle felt, a basic cloth including a grid structure can be hurt due to the fact that fine webs are struck on the basic cloth by the needle to be integrally formed with the basic cloth, or spots including cushion characteristics can generate if webs are not uniform. In addition, since the needle felt is integrally formed with the basic cloth simply by striking webs thereon, the webs can removed from the basic cloth due to a strong shower.

Such being the case, in order to prevent such removal of webs, the technique disclosed in a Patent Publication 2 was adopted. More specifically, in the Patent Publication 2, fused particles (corresponding to the webs) made of synthetic polymers are adhered to a basic cloth. Although, in this fabric, the fused particles are not easily removed from the basic cloth due to the fact that they are made integral with the basic cloth by means of a fusion bonding, they still tend to be removed from the basic cloth due to the shower, or when they are bent along a roll surface. Further, since the fused particles include neither the cushion characteristics nor the water-suction characteristics as a felt due to the fact that they are cured after the fusion, they do not tend to deform like the fiber web, so that they have a poor washing characteristics.

In particular, in the process in which the building material is pressed, since, in the above fabric, fine fibers are later provided on the basic cloth; the bristles can be easily fallen out by a strong washing shower. It is strongly desired to solve such a technical problem.

Patent Publication 1: Japanese Patent Laid-open Publication HEI09-241993

Patent Publication 2: Japanese Patent Laid-open Publication SHO61-225393

### DISCLOSURE OF THE INVENTION

Technical Problems to be Solved by Present Invention

The object of the present invention is to provide an industrial fabric used for forming and pressing processes which exhibits good water-suction property, while at the same time prevents spots from being generated and prevents bristles from being fallen out even if it is repeatedly used for the pressing process in case of the forming of the building material, or a strong washing shower is applied thereto.

Means to Solve Technical Problems

In view of the above technical problem, the present inventor found out that the bristle can be prevented from being fallen out by the fact that the industrial fabric used for forming and pressing processes is woven using fine yarns, and then yarns consisting of bundled small-diameter raw yarns such as mole or divided fibers are crossed by jetting water to the fabric in a columnar stream or a spray stream, and that the surface smoothness of the fabric can be improved by clamping the fibers on the surface. The present inventions comprise following elements.

1. An industrial fabric used for forming and pressing comprises one-layer fabric including warps and wefts constituting the fabric at least a part of which is woven by yarns consisting of bundled small-diameter raw yarns and fibers of the small-diameter raw yarns are crossed by jetting water in a columnar stream or a spray stream thereto, or multi-layer fabric including warps and wefts constituting an upper surface side layer at least a part of which is woven by yarns consisting of bundled small-diameter raw yarns and fibers of the small-diameter raw yarns are crossed by jetting water in a columnar stream or a spray stream thereto.

2. The industrial fabric used for forming and pressing according to claim 1, wherein the bundled small-diameter raw yarns are selected from a group consisting of a open-spun yarn, a multifilament, a Taslan processed yarn, a monofilament twine, a mole yarn, a filament processed yarn, a yarn in which a spun yarn is wound on a core line of a monofilament, a yarn in which a multifilament is wound on a core line of a monofilament, and a yarn in which at least two kinds of these yarns are co-twined.

3. The industrial fabric used for forming and pressing according to claim 1 or 2, wherein said warps constituting the fabric is a monofilament and no less than half of said upper wefts consist of yarns of the bundled small-diameter raw yarns to form a structure of a single warp-double weft type, or of a double warp-double weft type in which the upper wefts and lower wefts constituting a lower surface side layer are laminated.

4. The industrial fabric used for forming and pressing according to claim 1 or 2 wherein said warps constituting the fabric is a monofilament and no less than half of said upper wefts consist of yarns of the bundles small-diameter raw yarns to form a structure of a single warp-triple weft type in which the upper wefts and middle wefts constituting a middle layer, and lower wefts are laminated.

5. The industrial fabric used for forming and pressing according to claim 4, wherein said warp constituting the fabric is a monofilament and no less than half of said upper wefts consist of yarns of the bundled small-diameter raw yarns, and at least a part of either of said middle wefts or said lower wefts consist of yarns of the bundled small-diameter raw yarns to form a structure of a single warp-triple weft type in which the upper wefts, the middle wefts, and the lower wefts are laminated.

6. The industrial fabric used for forming and pressing according to claim 1 or 2, wherein said warp constituting the fabric is a monofilament and no less than half of said upper wefts consist of yarns of the bundled small-diameter raw yarns to form a structure of a single warp-single weft type.

7. The industrial fabric used for forming and pressing process according to any of claims 1 to 6, wherein at least a part of the warps constituting the fabric consists of yarns of the bundled small-diameter raw yarns.

A large filtering space can be secured even under a fine structure such as a felt whose fiber surface is covered with batt, since a raised condition can be realized only by a weaving process by adopting the above structure.

According to the fabric of the present invention, there is a technical advantage that the bristles can be prevented from being fallen out by the washing shower, due to the fact that the webs are not later provided, unlike the felt, and that the basic cloth can be prevented from being damaged due to the fact that the needle is not used during the forming process.

In case of the fabric to which water in the column or spray stream has not been jetted, since the yarns which are constituted by bundling small-diameter raw yarns are very soft, the yarns are collapsed so that the fabric tends to deteriorate when the pressing force is applied thereto, and as a result, the clogging or the shortage of the hydration are caused. By jetting water to the fabric in the column or the spray stream, the crossing of the fibers which is different from the pressing can be caused, so that a sufficient filtering space can be secured for a long time even under the fine fabric.

According to the industrial fabric used for a pressing of the present invention, the industrial fabric can be manufactured by weaving the fabric using the yarns constituted by the bundled small-diameter raw yarns, and then crossing the fibers of the yarns by jetting water to the fabric in the column or the spray stream.

More specifically, the fabric of the present invention consists of the warps and the wefts. The fabric is woven by applying the yarns consisting of the bundled small-diameter raw yarns to at least a part of the warps and/or the wefts constituting the upper surface side layer.

There are the fabric of a single warp-double weft type in which a monofilament is used for the warp, while the yarns consisting of the bundled small-diameter raw yarns are used for the upper wefts and a monofilament is used for the lower wefts, and the fabric of a single warp-triple weft type in which a monofilament is used for the warp, while the yarns consisting of the bundled small-diameter raw yarns are used for the upper wefts, a monofilament is used for the middle wefts and the yarns consisting of the bundled small-diameter raw yarns and a monofilament arranged in an alternate manner are used for the lower wefts. The yarns consisting of the bundled small-diameter raw yarns may be adopted as the warps.

Alternatively, any structures such those of a single warp-single weft type, a double warp-double weft type, a double warp-triple weft type may be adopted so long as at least a part of the warps and the wefts on the upper surface side defining a surface contacting the formed object, or preferably no less than half of them are constituted by the yarns consisting of the bundled small-diameter raw yarns. That is because the formed object is a very fine material such as a building material.

In addition, in the fabric of a double, or triple-layers type, it is preferable to adopt a structure of arranging the yarns consisting of the bundled small-diameter raw yarns on both middle and lower layers so as to efficiently hydrate due to a conduit forming phenomena in order to form a flow passage for water.

In the present invention, the fine surface can be obtained by crossing the fine fibers by jetting water to the fabric in a column or spray stream after the above yarns are woven.

Since the yarns consisting of the bundled small-diameter raw yarns are an aggregation of the small-diameter raw yarns, the small-diameter raw yarns can be dispersed to be crossed by striking a strong water flow such as a column or spray stream thereon, whereby they are appropriately clamped.

The column or spray stream is defined to be a water column (a water needle) of a needle punch jetted from a jet nozzle whose pressure amounts to 3˜30 MPa, more preferably, to 5˜15 MPa. If the pressure is lower than 3 MPa, the raw yarns cannot be crossed, while it is higher than 30 MPa, some raw yarns can split and it is not economically advantageous.

The water flow in the column stream is for practical use, but that in the spray stream which provides more minute stream may be adopted. By jetting water to the fabric in the column or spray stream, the fabric including a structure with a rigidity, a fineness and an uniformity like the needle felt, and a good cushion property can be obtained.

The yarns of the fabric consisting of the bundled small-diameter raw yarns may be selected from a group consisting of an open-spun yarn, a multifilament, a raising yarn, a monofilament twine, a mole yarn, a filament processed yarn, a yarn in which a spun yarn is wound on a core line of a monofilament, and a yarn in which at least two kinds of these yarns are co-twined.

In this connection, in the present invention, the spun yarn means a yarn formed by gathering and bundling short fibers, and includes a yarn manufactured by spinning, or the like. The multifilament means a yarn formed by gathering and bundling fine short fibers, and the raising yarn means a yarn formed by scratching the surface of the multifilament with a needle like material to cause nap. The filament processed yarn means a yarn formed by subjecting a filament yarn to expansion and contraction processing, sublime processing, crimp processing, or the like, and includes yarns generally called as a textured yarn, a bulky yarn, stretcher yarn, and a Taslan processed yarn, as well as a wooly nylon and the like.

The mole yarn is a yarn formed by arranging short fibers radially using a core yarn such as multifilament as an inner core. The yarn wherein the short fibers arranged radially is subjected to crimp processing or the like is also included.

A monofilament twist yarn or a twist yarn whose core line is the monofilament may be adopted as the monofilament. The monofilament used herein serves to improve the rigidity as well as the dimensional stability.

The material of the yarn is not particularly limited and various materials such as synthetic fibers including polyesters, polyamides, polyphenylene sulfide, etc., chemical fibers including rayon, etc., and natural fibers including cotton etc. can be used. When a polyamide is used as the weft at the running surface side, nip resistance to pressing, and fibrillation property become satisfactory, while the use of polyester increases rigidity. When polyester is used, the rigidity is increased, so that it is not easily neither extended nor deformed. Therefore, it is preferable to select the material of the yarn depending on the application. In particular, it is preferable to use polyamide for the wefts, in view of the technical problem of the splitting.

Effect of the Invention

According to the present invention, an industrial fabric used for forming and pressing building material which is capable of exhibiting a good water suction property, while at the same time of preventing spots from being generated and bristles from being fallen out even if it is repeatedly used for forming and pressing building material and a strong washing shower is applied thereto can be provided.

Embodiments of the present invention will be described below. The following embodiments are not intended to limit the present invention.

### EXAMPLE 1

A mole yarn formed by twisting a fancy yarn having a density of 1170 Tex and a length of 10 mm and three yarns each having a density of 167 Tex is arranged in the number of 16 per inch as an upper weft, while a polyester monofilament having a diameter of 0.90 mm is arranged in the number of 16 per inch as a lower weft, and a polyester monofilament having a diameter of 0.50 mm is arranged in the number of 52 per inch as a warp, and they are woven into a fabric of a single warp-double weft structure. The resultant fabric is made endless by a conventional manner, and then run at the speed of 10 m per minute, while water with a pressure of 12 MPa is jetted in a column stream from a nozzle with a diameter of 0.1 mm toward the surface of the fabric to cross the mole yarns of the upper wefts.

### EXAMPLE 2

A mole yarn formed by twisting a fancy yarn having a density of 1170 Tex and a length of 10 mm and three yarns each having a density of 167 Tex is arranged in the number of 20 per inch as an upper weft, while a polyester monofilament having a diameter of 0.45 mm is arranged in the number of 20 per inch as a middle weft, and a mole yarn the same as the upper weft and a polyester monofilament having a diameter of 0.40 mm are alternately arranged in the number of 20 per inch as a lower weft, and a polyester monofilament having a diameter of 0.35 mm is arranged in the number of 87 per inch as a warp, and they are woven into a fabric of a single warp-triple weft structure. The resultant fabric is made endless by a conventional manner, and then run at the speed of 10 m per minute, while water with a pressure of 12 MPa is jetted in a column stream from a nozzle with a diameter of 0.1 mm toward the surface of the fabric to cross the mole yarns of the upper wefts.

### EXAMPLE 3

A mole yarn formed by co-twisting a polyamide Taslan processed yarn having 540 denier and a burring processed yarn having 800 denier is arranged in the number of 28 per inch as an upper weft, while a polyester monofilament having a diameter of 0.40 mm is arranged in the number of 28 per inch as a middle weft, and a polyester monofilament having a diameter of 0.40 mm is arranged in the number of 28 per inch as a lower weft, and a polyester monofilament having a diameter of 0.35 mm is arranged in the number of 83 per inch as a warp, and they are woven into a fabric of a single warp-triple weft structure. The resultant fabric is made endless by a conventional manner, and then run at the speed of 10 m per minute, while water with a pressure of 12 MPa is jetted in a column stream from a nozzle with a diameter of 0.1 mm toward the surface of the fabric to cross the mole yarns of the upper wefts.

### EXAMPLE 4

A mole yarn formed by twisting a fancy yarn having a density of 1170 Tex and a length of 10 mm and three yarns each having a density of 167 Tex and a polyester monofilament having a diameter of 0.85 mm are alternately is arranged in the number of 20 per inch as a weft, while a polyester monofilament having a diameter of 0.50 mm is arranged in the number of 38 per inch as a warp, and they are woven into a fabric of single warp-single weft structure. The resultant fabric is made endless by a conventional manner, and then run at the speed of 10 m per minute, while water with a pressure of 12 MPa is jetted in a column stream from a nozzle with a diameter of 0.1 mm toward the surface of the fabric to cross the mole yarns of the upper wefts.

### COMPARATIVE EXAMPLE 1

As a basis cloth, a polyamide filament having a diameter of 0.33 mm is arranged in the number of 15 per inch as a weft, while two polyester monofilaments each having a diameter of 0.20 mm are twisted, and then three those polyester monofilaments are twisted to be arranged in the number of 20 per inch as a warp, and they are woven into a fabric of a single warp-single weft structure. Then, a needle felt is manufactured by needling the resultant fabric and webs in the number of 350 per square centimeter. This needle felt is comparative example 1.

### COMPARATIVE EXAMPLE 2

Fused particles each having a diameter of 0.15 mm are uniformly distributed on a basis cloth the same as that of the comparative example 1 so as to form holes sufficient to hydrate the surface of the fabric. Then, the fused particles are fused to be attached on the surface of the basis cloth at a temperature lower than that at which the yarns constituting the basis cloth are fused and higher than that at which object to be fused are fused. This is comparative example 2.

Field Test

With respect to the fabrics obtained by the examples 1 to 4, and the comparative examples 1, 2, a durability test was carried out using a machine for forming building materials run at a speed of 100 m per minute. The showering resistance, the durability, and the clogging were evaluated for each case based on how each fabric was used.

The test conditions are as follows.

Diameter of Nozzle: 1.0 mm

Shower Pressure: 4.0 MPa

Distance between Nozzle and Fabric: 200 mm

Surface on which shower is applied: Upper surface of the fabric

Sliding Speed: 50 mm per second in the weft direction

Testing Period: Until fibrillation (fine split), split, or falling out of bristles is generated

TABLE 1

| | Test period | |
|---|---|---|
| Sample | 10 days | 15 days |
| Example 1 | Mole yarns were | Almost no change. Uniform |
| | compressed. No problem | smoothness |
| Example 2 | Mole yarns were | Almost no change. Uniform |
| | compressed. No problem | smoothness |
| Example 3 | Co-twisted yarns were | Almost no change. Some |
| | compressed. No problem | Wear of monofilament of |
| | | lower weft |
| Example 4 | Mole yarns were | Uniform smoothness. Some |
| | compressed. No problem | Clogging generated due to |
| | | compression |
| Comparative | Falling out of bristles on a | Falling out of bristles |
| Example 1 | small scale | generated on a large scale |
| Comparative | Clogging generated. Break | Impossible to continue |
| Example 2 | of sheet generated due to | |
| | shortage of hydration | |
| | caused by no recovery of | |
| | compression | |

According to the test result, it was confirmed that, in the fabric of the present invention, bristles were hardly fallen out and that the surface was made uniform due to the fact that fine fibers were crossed without being collapsed by water-jet in a column stream.

On the tenth day from the test, in the examples 1 to 4, the fabric was appropriately used, since the smoothness of the surface and the washing property were good. However, in the comparative example 1, the bristles were gradually fallen out by the washing shower during its use, and the clogging of the material was generated due to the pressing, so that the duration of life was shortened. In the comparative example 2, it was confirmed that the fused object was not removed, but that a part of the hydration groove was clogged due to the fusion, in addition to that, since the compression was not recovered, water in the building material was not sufficiently hydrated, so that the break of the sheet was generated due to the shortage of the hydration.

On the fifteenth day from the field test, in the example 3, even though the monofilament of the lower weft gradually became worn, it was still be able to be practically used thereafter. In the example 4, even though the fabric gradually became clogged due to the collapse of the fine raw yarns, it was still be able to be practically used for a while.

1. An industrial fabric used for forming process and pressing process comprises one-layer fabric including warps and wefts constituting the fabric at least a part of which is woven by yarns consisting of bundled small-diameter raw yarns and fibers of the small-diameter raw yarns are crossed by jetting water in a columnar stream or a spray stream thereto, or multi-layer fabric including warps and wefts constituting an upper surface side layer at least a part of which is woven by yarns consisting of bundled small-diameter raw yarns and fibers of the small-diameter raw yarns are crossed by jetting water in a columnar stream or a spray stream thereto.

2. The industrial fabric used for forming process and pressing process according to claim 1, wherein the bundled small-diameter raw yarns are selected from a group consisting of an open-spun yarn, a multifilament, a Taslan processed yarn, a monofilament twine, a mole yarn, a filament processed yarn, a yarn in which a spun yarn is wound on a core line of a monofilament, a yarn in which a multifilament is wound on a core line of a monofilament, and a yarn in which at least two kinds of these yarns are co-twined.

3. The industrial fabric used for forming process and pressing process according to claim 1, wherein said warps constituting the fabric is a monofilament and no less than half of said upper wefts consist of yarns of the bundled small-diameter raw yarns to form a structure of a single warp-double weft type, or of a double warp-double weft type in which the upper wefts and lower wefts constituting a lower surface side layer are laminated.

4. The industrial fabric used for forming process and pressing process according to claim 1, wherein said warps constituting the fabric is a monofilament and no less than half of said upper wefts consist of yarns of the bundles small-diameter raw yarns to form a structure of a single warp-triple weft type in which the upper wefts and middle wefts constituting a middle layer, and lower wefts are laminated.

5. The industrial fabric used for forming process and pressing process according to claim 4, wherein said warp constituting the fabric is a monofilament and no less than half of said upper wefts consist of yarns of the bundled small-diameter raw yarns, and at least a part of either of said middle wefts or said lower wefts consist of yarns of the bundled small-diameter raw yarns to form a structure of a single warp-triple weft type in which the upper wefts, the middle wefts, and the lower wefts are laminated.

6. The industrial fabric used for forming process and pressing process according to claim 1, wherein said warp constituting the fabric is a monofilament and no less than half of said upper wefts consist of yarns of the bundled small-diameter raw yarns to form a structure of a single warp-single weft type.

7. The industrial fabric used for forming process and pressing process according to claim 1, wherein at least a part of the warps constituting the fabric consists of yarns of the bundled small-diameter raw yarns.
